(19) United States
(12) Patent Application Publication
(10) Pub. No.: US 2026/0316616 A1
(43) Pub. Date: Oct. 15, 2026

(54) Systems and Methods for Grid-Supportive EV Charging

(71) Applicant: California Institute of Technology, Pasadena, CA (US)

(72) Inventor: Steven H. Low, La Canada, CA (US)

(73) Assignee: California Institute of Technology, Pasadena, CA (US)

(21) Appl. No.: 19/647,484

(22) Filed: Apr. 14, 2026

Related U.S. Application Data
(60) Provisional application No. 63/788,290, filed on Apr. 14, 2025.

(51) Int. Cl. B60L 53/62; B60L 53/51; B60L 53/64; B60L 53/68; H02J 3/17; H02J 3/38; H02J 13/13; H02J 101/24

(52) U.S. Cl. CPC B60L 53/62; B60L 53/51; B60L 53/64; B60L 53/68; H02J 3/17; H02J 3/38; H02J 13/1311; H02J 2101/24

(57) ABSTRACT

A method for decentralized electric vehicle charging includes initializing, by a first smart charger connected to a distribution transformer, a charging current magnitude to zero when a first electric vehicle connects. The method further includes broadcasting the charging current magnitude via power line communication to a plurality of other smart chargers connected to the same distribution transformer, changing the charging current magnitude by an increment and broadcasting the increment via power line communication, receiving a plurality of voltage sensitivity values from the plurality of other smart chargers, wherein each voltage sensitivity value is based upon a change in voltage at a respective other smart charger in response to the increment, weighted by how close the voltage at the respective other smart charger is to a voltage limit, and determining an updated charging current magnitude based on a priority weight and a sum of the plurality of voltage sensitivity values.

### CROSS-REFERENCE TO RELATED APPLICATIONS

The present application claims benefit under 35 U.S.C. 119(e) to U.S. Provisional Patent Application No. 63/788,290, titled “Methods for Grid-Supportive EV Charging”, filed Apr. 14, 2025, the disclosures of which are incorporated herein by reference in their entirety.

### FIELD OF THE INVENTION

The present disclosure relates to electric vehicle charging systems, and more particularly to systems and methods for grid-supportive coordination of electric vehicle charging to optimize distribution transformer utilization and maintain voltage stability across power distribution networks.

### BACKGROUND

Electric vehicles (EVs), which include plug-in hybrid electric vehicles (PHEVs), use electric motors for propulsion and require charging from the electrical grid. EV adoption has been spurred by various government policies and incentives. As EV adoption continues to grow, the additional load that EVs place on the electrical grid becomes increasingly significant. An EV's power demand can be many times that of an average residential house, and when multiple EVs charge simultaneously in a neighborhood or facility, the aggregate demand can strain local electrical infrastructure.

The electrical grid delivers power from centralized generation sources through transmission lines to substations, and then through distribution networks to end users. Distribution transformers serve as the interface between medium-voltage distribution feeders and low-voltage service to residential and commercial customers. Multiple homes or businesses typically share a single distribution transformer. When distributed energy resources (DERs) such as EVs and photovoltaic (PV) systems are deployed at scale, they can affect voltage levels at customer locations and increase loading on distribution transformers. Distribution grids are often sparsely monitored, with limited real-time visibility into conditions at the distribution transformer level.

Existing EV charging technologies may adjust charging rates based on how many chargers share the same power supply, or may coordinate charging within a single facility based on local capacity constraints. However, coordinating EV charging across multiple locations that share common distribution infrastructure presents additional complexities. Therefore, improved systems and methods for coordinating EV charging in a manner that accounts for distribution grid conditions may be desirable.

### SUMMARY OF INVENTION

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

One embodiment includes a method for decentralized electric vehicle charging. The method includes initializing, by a first smart charger connected to a distribution transformer, a charging current magnitude to zero when a first electric vehicle connects to the first smart charger. The method includes broadcasting, by the first smart charger, the charging current magnitude via power line communication to a plurality of other smart chargers connected to the same distribution transformer. The method includes changing, by the first smart charger, the charging current magnitude by an increment and broadcasting the increment via power line communication. The method includes receiving, by the first smart charger, a plurality of voltage sensitivity values from the plurality of other smart chargers via power line communication, wherein each voltage sensitivity value is based upon a change in voltage at a respective other smart charger in response to the increment, weighted by how close the voltage at the respective other smart charger is to a voltage limit. The method includes determining, by the first smart charger, an updated charging current magnitude based on a priority weight and a sum of the plurality of voltage sensitivity values.

In another embodiment, each voltage sensitivity value is computed according to:

$${β}_{k} ( t ) := ( {\underline{λ}}_{k} ( t ) - {\overline{λ}}_{k} ( t ) ) \frac{Δ {v}_{k} ( t )}{Δ {x}_{j} ( t )}$$

wherein λₖ(t) is a lower voltage tracking variable, λ̅ₖ(t) is an upper voltage tracking variable, Δvₖ(t) is a change in squared voltage magnitude, and Δxⱼ(t) is the increment.

In yet another embodiment, determining the updated charging current magnitude includes computing:

xⱼ(t+1)←[xⱼ(t)+γⱼ₁(αⱼ+Σₖβₖ(t))]⁺

wherein αⱼ is the priority weight, γⱼ₁ is a positive stepsize, βₖ(t) are the voltage sensitivity values, and [μ]⁺:=max{μ, 0}.

In a further embodiment, the method further includes receiving, by the first smart charger, an apparent power sensitivity value from an optimal power flow controller installed at the distribution transformer via power line communication, wherein the apparent power sensitivity value is based on a change in apparent power at the distribution transformer in response to the increment, weighted by how close the apparent power is to a rated capacity of the distribution transformer. The method further includes determining the updated charging current magnitude based on the priority weight, the sum of the plurality of voltage sensitivity values, and the apparent power sensitivity value.

In still another embodiment, the apparent power sensitivity value is computed according to:

$${β}_{0} ( t ) := - {\overline{λ}}_{0} ( t ) \frac{Δ {s}_{0} ( t )}{Δ {x}_{j} ( t )}$$

wherein λ̅₀(t) is an apparent power tracking variable that tracks how close the apparent power is to the rated capacity of the distribution transformer, Δs₀(t) is the change in apparent power at the distribution transformer, and Δxⱼ(t) is the increment.

In an additional embodiment, the method further includes detecting, by the first smart charger, that the optimal power flow controller is unavailable when no apparent power sensitivity value is received within a specific time period. The method further includes continuing to operate using only the plurality of voltage sensitivity values received from the plurality of other smart chargers without the apparent power sensitivity value.

In yet a further embodiment, the method further includes detecting, by the first smart charger, that the optimal power flow controller is available when the apparent power sensitivity value is received. The method further includes resuming operation using both the plurality of voltage sensitivity values and the apparent power sensitivity value.

In another embodiment, the first smart charger controls a photovoltaic inverter, and a partial derivative of voltage with respect to current magnitude is positive such that photovoltaic generation raises local voltages.

In still a further embodiment, the method further includes receiving, by the first smart charger, an energy demand and a deadline from the first electric vehicle, wherein the energy demand represents remaining energy required and the deadline represents duration available for charging. The method further includes setting the priority weight proportional to a laxity of the first electric vehicle, wherein the laxity is computed as the energy demand divided by the deadline.

One embodiment includes a method for transformer-protecting electric vehicle charging. The method includes receiving, by an optimal power flow controller installed at a distribution transformer, a charging current magnitude broadcast from a smart charger via power line communication. The method includes measuring, by the optimal power flow controller, apparent power at the distribution transformer. The method includes receiving, by the optimal power flow controller, an increment in the charging current magnitude broadcast from the smart charger via power line communication. The method includes measuring, by the optimal power flow controller, a new apparent power at the distribution transformer. The method includes computing, by the optimal power flow controller, an apparent power sensitivity value based on a ratio of a change in apparent power to the increment, weighted by how close the apparent power is to a rated capacity of the distribution transformer. The method includes broadcasting, by the optimal power flow controller, the apparent power sensitivity value to the smart charger via power line communication.

In another embodiment, the apparent power sensitivity value is computed according to:

$${β}_{0} ( t ) := - {\overline{λ}}_{0} ( t ) \frac{Δ {s}_{0} ( t )}{Δ {x}_{j} ( t )}$$

wherein λ̅₀(t) is an apparent power tracking variable that tracks how close the apparent power is to the rated capacity of the distribution transformer, Δs₀(t) is the change in apparent power at the distribution transformer, and Δxⱼ(t) is the increment.

In yet another embodiment, the method further includes updating, by the optimal power flow controller, an apparent power tracking variable based on a difference between the rated capacity of the distribution transformer and the measured apparent power.

One embodiment includes a smart charger system for decentralized electric vehicle charging. The smart charger system includes an optimal power flow receiver including a processor, an input/output interface configured to communicate via power line communication with a plurality of other smart chargers connected to a distribution transformer, and a memory storing a decentralized charging application. The decentralized charging application, when executed by the processor, causes the processor to initialize a charging current magnitude to zero when an electric vehicle connects. The decentralized charging application causes the processor to broadcast the charging current magnitude via power line communication to the plurality of other smart chargers. The decentralized charging application causes the processor to change the charging current magnitude by an increment and broadcast the increment via power line communication. The decentralized charging application causes the processor to receive a plurality of voltage sensitivity values from the plurality of other smart chargers via power line communication, wherein each voltage sensitivity value is based upon a change in voltage at a respective other smart charger in response to the increment, weighted by how close the voltage at the respective other smart charger is to a voltage limit. The decentralized charging application causes the processor to determine an updated charging current magnitude based on a priority weight and a sum of the plurality of voltage sensitivity values.

In another embodiment, each voltage sensitivity value is computed according to:

$${β}_{k} ( t ) := ( {\underline{λ}}_{k} ( t ) - {\overline{λ}}_{k} ( t ) ) \frac{Δ {v}_{k} ( t )}{Δ {x}_{j} ( t )}$$

wherein λₖ(t) is a lower voltage tracking variable, λ̅ₖ(t) is an upper voltage tracking variable, Δvₖ(t) is a change in squared voltage magnitude, and Δxⱼ(t) is the increment.

In yet another embodiment, the decentralized charging application further causes the processor to determine the updated charging current magnitude by computing:

xⱼ(t+1)←[xⱼ(t)+γⱼ₁(αⱼ+Σₖβₖ(t))]⁺

wherein αⱼ is the priority weight, γⱼ₁ is a positive stepsize, βₖ(t) are the voltage sensitivity values, and [μ]⁺:=max{μ, 0}.

In a further embodiment, the decentralized charging application further causes the processor to receive an apparent power sensitivity value from an optimal power flow controller installed at the distribution transformer via power line communication. The decentralized charging application further causes the processor to determine the updated charging current magnitude based on the priority weight, the sum of the plurality of voltage sensitivity values, and the apparent power sensitivity value.

In still another embodiment, the apparent power sensitivity value is computed according to:

$${β}_{0} ( t ) := - {\overline{λ}}_{0} ( t ) \frac{Δ {s}_{0} ( t )}{Δ {x}_{j} ( t )}$$

wherein λ̅₀(t) is an apparent power tracking variable that tracks how close the apparent power is to the rated capacity of the distribution transformer, Δs₀(t) is the change in apparent power at the distribution transformer, and Δxⱼ(t) is the increment.

In an additional embodiment, the decentralized charging application further causes the processor to detect that the optimal power flow controller is unavailable when no apparent power sensitivity value is received within a specific time period. The decentralized charging application further causes the processor to continue to operate using only the plurality of voltage sensitivity values received from the plurality of other smart chargers without the apparent power sensitivity value.

In yet a further embodiment, the decentralized charging application further causes the processor to detect that the optimal power flow controller is available when the apparent power sensitivity value is received. The decentralized charging application further causes the processor to resume operation using both the plurality of voltage sensitivity values and the apparent power sensitivity value.

In another embodiment, the optimal power flow receiver is configured to control a photovoltaic inverter, and a partial derivative of voltage with respect to current magnitude is positive such that photovoltaic generation raises local voltages.

In still a further embodiment, the decentralized charging application further causes the processor to receive an energy demand and a deadline from the electric vehicle, wherein the energy demand represents remaining energy required and the deadline represents duration available for charging. The decentralized charging application further causes the processor to set the priority weight proportional to a laxity of the electric vehicle, wherein the laxity is computed as the energy demand divided by the deadline.

One embodiment includes an optimal power flow controller for transformer-protecting electric vehicle charging. The optimal power flow controller includes a processor, an input/output interface configured to communicate via power line communication with a plurality of smart chargers connected to a distribution transformer, and a memory storing an optimal charging application. The optimal charging application, when executed by the processor, causes the processor to receive a charging current magnitude broadcast from a smart charger. The optimal charging application causes the processor to measure apparent power at the distribution transformer. The optimal charging application causes the processor to receive an increment in the charging current magnitude broadcast from the smart charger. The optimal charging application causes the processor to measure a new apparent power at the distribution transformer. The optimal charging application causes the processor to compute an apparent power sensitivity value based on a ratio of a change in apparent power to the increment, weighted by how close the apparent power is to a rated capacity of the distribution transformer. The optimal charging application causes the processor to broadcast the apparent power sensitivity value to the smart charger via power line communication.

In another embodiment, the apparent power sensitivity value is computed according to:

$${β}_{0} ( t ) := - {\overline{λ}}_{0} ( t ) \frac{Δ {s}_{0} ( t )}{Δ {x}_{j} ( t )}$$

wherein λ̅₀(t) is an apparent power tracking variable that tracks how close the apparent power is to the rated capacity of the distribution transformer, Δs₀(t) is the change in apparent power at the distribution transformer, and Δxⱼ(t) is the increment.

In yet another embodiment, the optimal charging application further causes the processor to update an apparent power tracking variable based on a difference between the rated capacity of the distribution transformer and the measured apparent power.

In a further embodiment, the optimal charging application further causes the processor to collect energy demands and deadlines from a plurality of electric vehicles connected to the distribution transformer. The optimal charging application further causes the processor to construct an optimization problem to minimize a cost function subject to voltage constraints, apparent power constraints, and energy demand constraints. The optimal charging application further causes the processor to broadcast optimal charging current magnitudes to the plurality of electric vehicles.

One embodiment includes a smart charger for decentralized electric vehicle charging. The smart charger includes a processor, an input/output interface configured to communicate via power line communication with a plurality of other smart chargers connected to a distribution transformer, and a memory storing a decentralized charging application. The decentralized charging application, when executed by the processor, causes the processor to initialize a charging current magnitude to zero when an electric vehicle connects. The decentralized charging application causes the processor to broadcast the charging current magnitude via power line communication to the plurality of other smart chargers. The decentralized charging application causes the processor to change the charging current magnitude by an increment and broadcast the increment via power line communication. The decentralized charging application causes the processor to receive a plurality of voltage sensitivity values from the plurality of other smart chargers via power line communication, wherein each voltage sensitivity value is based upon a change in voltage at a respective other smart charger in response to the increment, weighted by how close the voltage at the respective other smart charger is to a voltage limit. The decentralized charging application causes the processor to determine an updated charging current magnitude based on a priority weight and a sum of the plurality of voltage sensitivity values.

The foregoing general description of the illustrative embodiments and the following detailed description thereof are merely exemplary aspects of the teachings of this disclosure and are not restrictive.

### BRIEF DESCRIPTION OF THE DRAWINGS

FIG. 1 illustrates a power distribution system in accordance with an embodiment of the invention.

FIG. 2A illustrates a block diagram of a grid-supportive EV charging system in accordance with an embodiment of the invention.

FIG. 2B illustrates a block diagram of a grid-supportive EV charging system without an OPF controller in accordance with an embodiment of the invention.

FIG. 3 illustrates a block diagram of an OPF receiver in accordance with an embodiment of the invention.

FIG. 4 illustrates a block diagram of an OPF controller in accordance with an embodiment of the invention.

FIG. 5 illustrates a system diagram of a grid-supportive distributed energy resource management system in accordance with an embodiment of the invention.

FIG. 6 illustrates a flowchart for a process for decentralized EV charging in accordance with an embodiment of the invention.

FIG. 7 illustrates a flowchart for a process for transformer-protecting charging in accordance with an embodiment of the invention.

FIG. 8 illustrates a flowchart for a process for transitioning between charging modes in accordance with an embodiment of the invention.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

Distributed energy resources (DERs) such as electric vehicles (EVs) and photovoltaic (PV) systems are growing rapidly and increasingly straining the distribution grid. This growth has caused voltage issues at customer locations and overloaded or even blown out distribution transformers. Distribution grids are very sparsely monitored, with few phasor measurement units beyond supervisory control and data acquisition (SCADA) systems at substations and smart meters at utility customers, operating at slow timescales. This lack of real-time grid visibility makes it difficult to dynamically manage large-scale residential and commercial EV charging to avoid overloading transformers and causing voltage issues in the distribution system.

Adaptive EV charging technologies on the current market usually adjust charging rates based on how many chargers are sharing the same power supply. More sophisticated approaches use models having predictive control capabilities to adaptively adjust all EV chargers within a charging facility, such as an airport or workplace, based on the capacity of the local distribution grid within the facility. Such approaches, however, are not applicable to the residential market, as they are not aware of grid conditions such as distribution transformer loading. At scale, these approaches can nonetheless overload transformers and cause voltage problems on a distribution grid.

Leveraging a key insight where EV charging has a strong impact on the voltage that each charger can measure locally, systems and methods in accordance with various embodiments of the invention provide a grid-supportive charging system that can charge EVs in a way that is decentralized yet can restrict the voltages at the houses to stay within their limits. In many embodiments, grid-supportive charging systems utilize local voltages that can carry information not just on the charging rate of the local EV charger but also charging rates of other chargers on the same or a nearby transformer. Since these voltages are related to transformer loading, this can alleviate transformer overloading.

In many embodiments, grid-supportive charging systems provide grid-supportive DER management, and can be applied to any controllable DERs such as EV chargers, energy storage devices, pool pumps, heat pumps, PV inverters, air conditioners, and other controllable loads. Grid-supportive charging systems in accordance with several embodiments of the invention can overcome the bottleneck problem presented by the lack of real-time grid visibility and optimize EV charging, or grid-supportive DER management in general, in residential and commercial markets. In a number of embodiments, grid-supportive charging systems allow smart chargers in a residential area or smart charging garages on a distribution feeder to share distribution transformers as safely, efficiently, and fairly as possible. Grid-supportive charging systems in accordance with various embodiments of the invention may prevent large-scale EV charging from overloading distribution grids, thus deferring infrastructure upgrades and preventing costly outages.

In many embodiments, grid-supportive charging systems can operate in one of three modes, with increasing functionality and complexity. In a first mode, referred to as decentralized charging, all EVs connected to the same distribution transformer coordinate among themselves via power line communication (PLC) to charge efficiently and fairly in a way that maintains their local voltages within safe limits, and thus indirectly reduces the risk of transformer overload. In a second mode, referred to as transformer-protecting charging, a distribution transformer utilizing an optimal flow (OPF) controller installed on the transformer can coordinate the charging of all EVs connected to the distribution transformer to charge efficiently and fairly while maintaining local voltage limits and avoiding transformer overload. In a third mode, referred to as grid-supporting charging, OPF controllers installed on different distribution transformers on a distribution feeder coordinate through the cloud to provide grid services, in addition to efficient, fair, and transformer-protecting charging.

Grid-supportive charging systems in accordance with several embodiments of the invention employ a model-free, measurement-based approach to determine voltage sensitivity. Voltage sensitivity captures the electrical coupling between chargers on the grid by measuring how much the voltage at one charger changes when another charger changes its charging current magnitude. Grid-supportive charging systems do not need to know the exact functional form of the voltage function and its partial derivatives—the sensitivity is measured empirically through perturbation. This approach allows chargers to coordinate without requiring a detailed model of the distribution grid.

In a number of embodiments, grid-supportive charging systems include a Sensing to Intelligence (S2I) layer architecture. S2I layers in accordance with several embodiments of the invention interface with different DERs below and enables different applications above. The S2I layer can decouple the application layer above from the physical DER layer below, allowing each layer to be implemented asynchronously and evolve independently. In certain embodiments, S2I layers sense and receive various data, both real-time and historical, both behind the meter, on a distribution grid and from the cloud. The S2I layer can synthesize the data into various models useful for different applications.

In various embodiments, grid-supportive charging systems may provide compatibility with demand response programs via Open Automated Demand Response (OpenADR). Grid-supportive charging systems in accordance with many embodiments of the invention may provide grid services such as transformer protection, voltage control, demand response, and feeder peak load management. Grid-supportive charging systems may include subsystems for sensing and data acquisition, communication via cellular, WiFi, powerline, and cloud, data processing, storage and analysis, and real-time control and optimization of DERs.

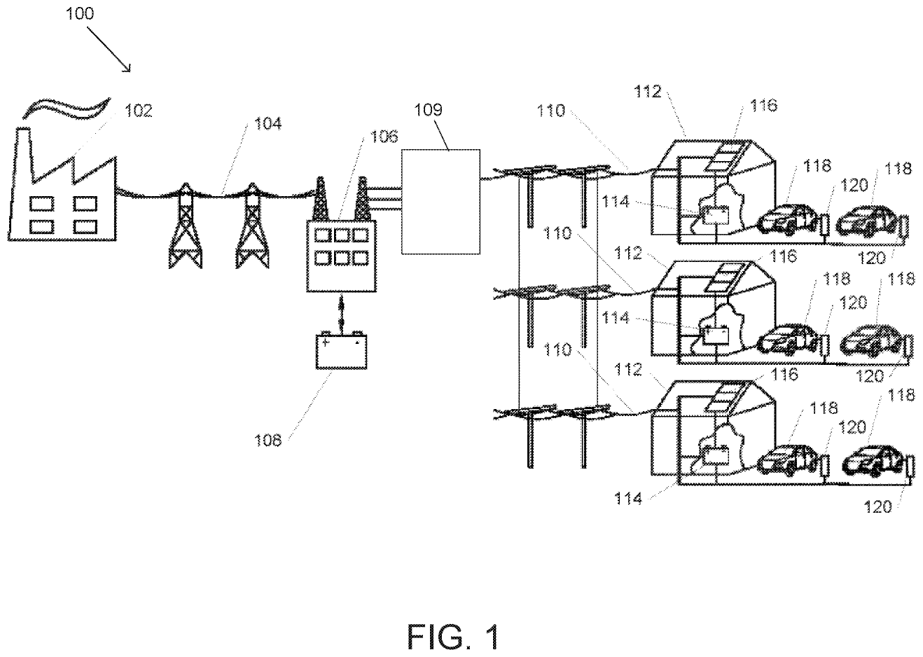

A power distribution system in accordance with an embodiment of the invention is illustrated in FIG. 1. The power distribution system 100 illustrates a power distribution network from generation to end-use locations where electric vehicles (EVs) receive charging and other loads receive power. Power distribution system 100 includes a power generator 102 that generates electricity. The power generator 102 may represent a power source including those using fossil fuels, nuclear, solar, wind, or hydroelectric power. Power distribution system 100 further includes power transmission lines 104 that transmit electricity between the power generator 102 and a power substation 106. The power substation 106 changes the voltage of the electricity for more efficient power distribution. The power substation 106 may connect to one or more large storage batteries 108, which can temporarily store electricity. A distribution transformer 109 receives power from the power substation 106 and supplies power to end-use locations. The distribution transformer 109 steps down the voltage from the medium-voltage distribution level to the low-voltage level suitable for residential and commercial use. The distribution transformer 109 can use mutual induction to transfer power between its primary and secondary windings, electrically isolating the distribution feeder from the end-use locations while maintaining power transfer. Power distribution lines 110 carry electricity to the distribution transformer 109 to one or more adaptive charging networks 112.

Each adaptive charging network 112 may include a battery 114 for local energy storage, solar panels 116 for distributed power generation, EVs 118 that receive charging, and chargers 120 that connect the EVs 118 to the adaptive charging network 112. The solar panels 116 are distributed power generation sources that may generate power to supply the chargers 120 as well as generate additional power for the power grid. The chargers 120 interface between the adaptive charging network 112 and the EVs 118, enabling the EVs 118 to draw power from the distribution network. In many embodiments, multiple EVs connect to an adaptive charging network at the chargers. Some adaptive charging networks may charge a small number of EVs, while other adaptive charging networks have the necessary infrastructure to charge dozens or even hundreds of EVs simultaneously.

In various embodiments, power distribution systems provide a hierarchical structure from centralized generation through transmission and distribution infrastructure to end-point EV charging locations. Power generators in accordance with several embodiments of the invention produce electricity that flows through power transmission lines to power substations. Power substations in accordance with many embodiments of the invention step down voltage levels and connect to large storage batteries for temporary electricity storage. Distribution transformers in accordance with a number of embodiments of the invention receive power from power substations via power distribution lines and supply power to adaptive charging networks serving residential or commercial locations.

In several embodiments, adaptive charging networks include various DERs in addition to EV chargers. DERs may include energy storage devices, pool pumps, heat pumps, PV inverters, air conditioners, and other controllable loads. Batteries within adaptive charging networks may provide local energy storage that supplements power received from the distribution network. Solar panels within adaptive charging networks may provide renewable energy generation that reduces demand on the distribution network and may supply excess power back to the power grid.

In many embodiments of the invention, chargers within adaptive charging networks communicate with each other and with distribution transformers to coordinate EV charging. Chargers in accordance with various embodiments of the invention may adjust charging rates based on grid conditions such as distribution transformer loading and voltage levels at customer locations. In a number of embodiments, multiple adaptive charging networks share a single distribution transformer, and chargers within those adaptive charging networks coordinate to avoid overloading the shared distribution transformer.

Although specific power distribution systems are described above with reference to FIG. 1, any of a variety of power distribution networks including adaptive charging networks may be utilized as appropriate to the requirements of specific applications in accordance with various embodiments of the invention. The number and arrangement of power generators, power substations, distribution transformers, and adaptive charging networks may vary depending on the specific implementation. Additionally, the types of DERs included within adaptive charging networks may vary based on the requirements of particular installations.

### Grid-Supportive EV Charging Systems

Grid-supportive EV charging systems in accordance with various embodiments of the invention address the lack of real-time grid visibility by enabling chargers to coordinate via PLC without requiring detailed knowledge of the distribution grid topology. Rather than relying on centralized control or facility-level optimization, grid-supportive EV charging systems leverage local voltage measurements and peer-to-peer communication to maintain voltage stability and avoid transformer overload.

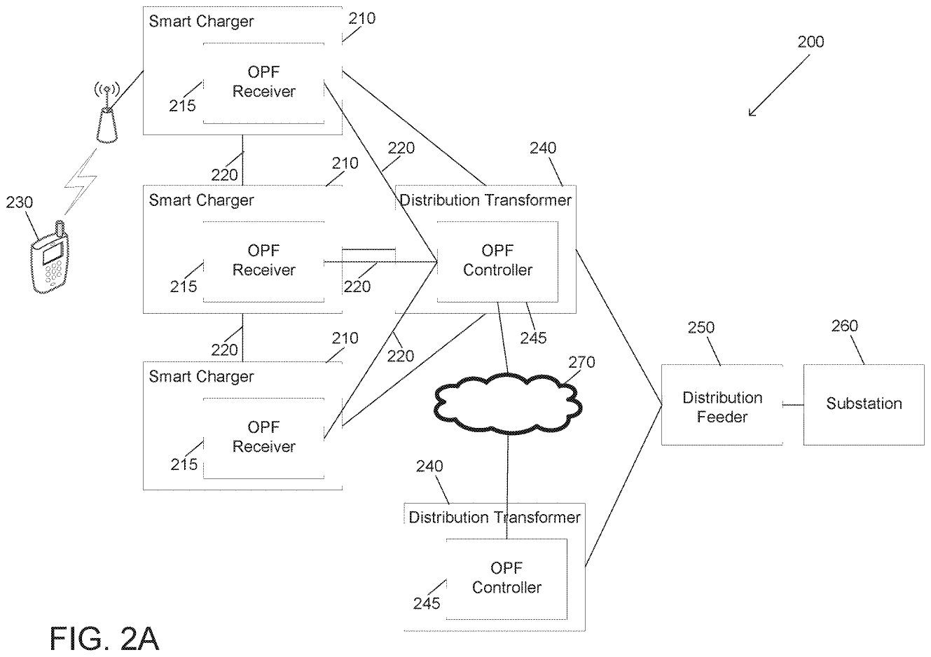

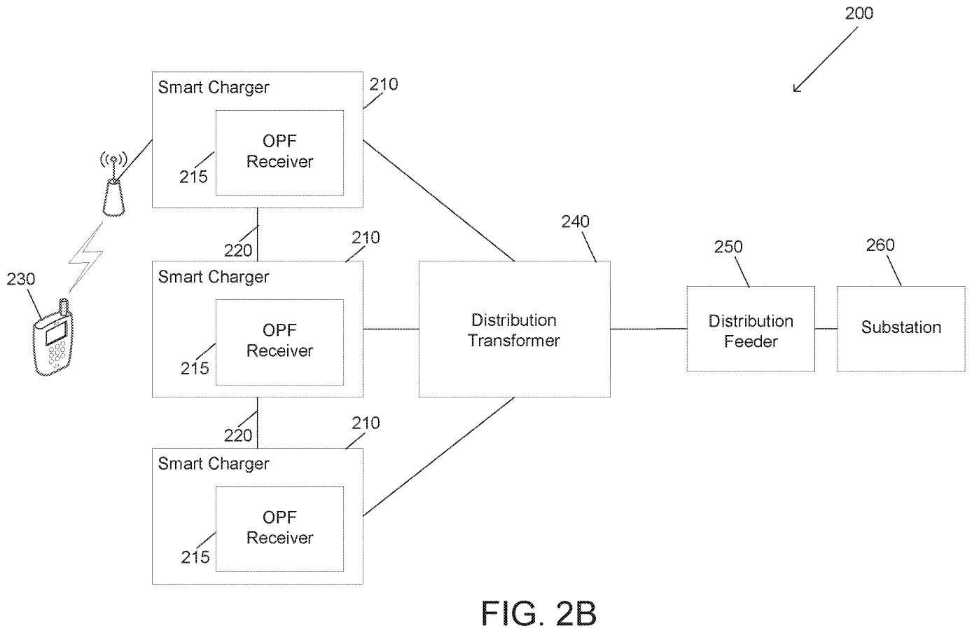

A grid-supportive EV charging system in accordance with an embodiment of the invention is illustrated in FIG. 2A. Referring to FIG. 2A, a grid-supportive EV charging system 200 includes a plurality of smart chargers 210, each smart charger 210 containing an OPF receiver 215, a distribution transformer 240 containing an OPF controller 245, a mobile device 230, a cloud 270, a distribution feeder 250, and a substation 260. The smart chargers 210 connect to the distribution transformer 240 via PLC connections 220, which enable PLC between the OPF receivers 215 within the smart chargers 210 and the OPF controller 245 within the distribution transformer 240. The PLC connections 220 also facilitate peer-to-peer communication among the OPF receivers 215 in different smart chargers 210 that connect to the same distribution transformer 240. The mobile device 230 communicates wirelessly with one of the smart chargers 210, allowing a user to provide input such as energy demands and departure times. The distribution transformer 240 connects to the distribution feeder 250, which supplies power from the substation 260. The OPF controller 245 within the distribution transformer 240 connects to the cloud 270, enabling communication with other OPF controllers at other distribution transformers on the same feeder.

In various embodiments, OPF receivers may be installed in a household or a smart charging garage and may communicate with and control smart chargers in that household or garage. OPF receivers in accordance with several embodiments of the invention may also communicate with OPF receivers in other households connected to the same distribution transformer. In many embodiments, OPF receivers communicate using Open Charge Point Protocol (OCPP) with OCPP-enabled chargers, which facilitates interoperability among different charger manufacturers and operators. OPF receivers may interface with standard smart chargers to enable the smart chargers to participate in decentralized charging processes. In a number of embodiments, OPF receivers include PLC capability and software that may not be present in standard smart chargers.

With continued reference to FIG. 2, PLC in accordance with many embodiments of the invention can occur between OPF receivers on the same transformer and between OPF receivers and the OPF controller. In several embodiments, the PLC signal is blocked by the distribution transformer, which naturally limits communication to chargers connected to the same distribution transformer. This natural boundary may allow chargers to automatically communicate only with other chargers on the same transformer without requiring knowledge of the transformer to which the chargers connect. Grid-supportive EV charging systems in accordance with various embodiments of the invention may leverage this property of PLC to enable decentralized coordination processes.

In a number of embodiments, OPF controllers may be installed at distribution transformers and may communicate with all OPF receivers in households connected to the same transformer. OPF controllers in accordance with several embodiments of the invention may measure voltage and current at the transformer and may compute apparent power values. In many embodiments, OPF controllers receive current magnitude information broadcast from chargers via PLC and may compute sensitivity values based on changes in apparent power resulting from changes in charger current magnitudes. OPF controllers can broadcast computed sensitivity values to chargers via PLC, enabling chargers to adjust charging current magnitudes to avoid overloading the transformer.

Grid-supportive EV charging systems in accordance with various embodiments of the invention can include mobile device interfaces that allow users to provide input to smart chargers. In several embodiments, users may input energy demands and departure times via a mobile device or a user interface on the charger. In a number of embodiments, inputs may be automatically provided by the EV or a remote service that utilizes data analysis or machine learning to estimate parameters such as estimated departure time.

In many embodiments, cloud connectivity enables communication between OPF controllers on different transformers. In grid-supportive mode, OPF controllers at distribution transformers on a distribution feeder may coordinate not only with OPF receivers connected to their own transformers, but also with other OPF controllers via the cloud. Cloud connectivity in accordance with several embodiments of the invention may enable data processing, storage, and analysis. Grid-supportive EV charging systems may include subsystems for communication via cellular, WiFi, powerline, and cloud connections.

An alternative grid-supportive EV charging system in accordance with an embodiment of the invention is illustrated in FIG. 2B. The grid-supportive EV charging system of FIG. 2B is similar to the grid-supportive EV charging system of FIG. 2A, except that the distribution transformer 240 does not include an OPF controller. In this configuration, the OPF receivers 215 within the smart chargers 210 communicate with each other via PLC connections 220 to coordinate charging without receiving apparent power sensitivity values from an OPF controller. The OPF receivers 215 coordinate among themselves to maintain local voltages within safe limits, which indirectly reduces the risk of transformer overload. The mobile device 230 communicates wirelessly with one of the smart chargers 210, allowing a user to provide input such as energy demands and departure times. The distribution transformer 240 connects to the distribution feeder 250, which supplies power from the substation 260.

In various embodiments, grid-supportive EV charging systems may operate in either the configuration shown in FIG. 2A or the configuration shown in FIG. 2B. In the configuration of FIG. 2A, the OPF controller 245 provides apparent power sensitivity values to the smart chargers 210, enabling transformer-protecting charging that directly avoids transformer overload. In the configuration of FIG. 2B, the smart chargers 210 coordinate among themselves using only voltage sensitivity values, enabling decentralized charging that indirectly reduces the risk of transformer overload by maintaining local voltages within safe limits. The communication and computation performed by a smart charger may remain the same whether or not an OPF controller is present, and the transformer-protecting method may gracefully fall back to the decentralized method if the OPF controller is not installed or becomes unavailable. This fallback mechanism may allow the charging system to continue functioning even when the OPF controller becomes unavailable, maintaining grid protection through voltage-based feedback among the chargers.

Grid-supportive EV charging systems in accordance with several embodiments of the invention can provide compatibility with demand response programs via OpenADR. In many embodiments, grid-supportive EV charging systems provide grid services such as transformer protection, voltage control, demand response, and/or feeder peak load management. Grid-supportive EV charging systems may include subsystems for sensing and data acquisition, communication, data processing, storage and analysis, and real-time control and optimization of DERs.

Although specific grid-supportive EV charging systems are described above with reference to FIGS. 2A-2B, any of a variety of systems including OPF receivers and OPF controllers may be utilized as appropriate to the requirements of specific applications in accordance with various embodiments of the invention. The number and arrangement of smart chargers, additional power loads, OPF receivers, distribution transformers, and OPF controllers may vary depending on the specific implementation. Additionally, the communication protocols and interfaces used within grid-supportive EV charging systems may vary based on the requirements of particular installations.

### OPF Receivers

In various embodiments, OPF receivers enable decentralized coordination of electric vehicle charging among multiple chargers connected to the same distribution transformer. OPF receivers may be installed in households or smart charging garages and may communicate with and control smart chargers in those locations. OPF receivers in accordance with several embodiments of the invention may also communicate with OPF receivers in other households connected to the same distribution transformer via PLC. Both OPF receivers and OPF controllers may make local measurements, infer current grid conditions, and adjust charging rates to collaboratively deliver the required energy to every EV within its deadline efficiently and fairly.

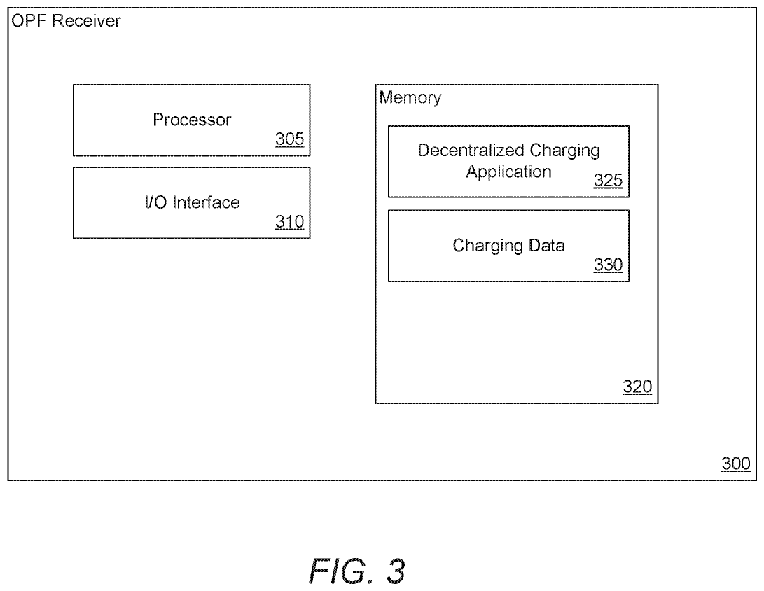

An OPF receiver in accordance with an embodiment of the invention is illustrated in FIG. 3. Referring to FIG. 3, an OPF receiver 300 includes a processor 305, an I/O interface 310, and a memory 320, where the memory 320 contains a decentralized charging application 325 and charging data 330. The processor 305 may execute instructions and perform computational operations for the OPF receiver 300. The I/O interface 310 may facilitate communication between the OPF receiver 300 and external devices, including (but not limited to) smart chargers and other OPF receivers connected to the same distribution transformer via PLC. The memory 320 may store software and data used by the processor 305. The decentralized charging application 325 may include instructions that configure the processor 305 to perform decentralized charging operations, including (but not limited to) broadcasting current magnitude values via PLC, receiving voltage sensitivity values from other chargers, and updating charging current magnitude based on received feedback. The charging data 330 may store parameters related to charging sessions, which may include current magnitude values, voltage measurements, priority weights, and voltage sensitivity values received from other OPF receivers.

In many embodiments, OPF receivers measure the squared voltage magnitude at the local house to detect grid impact from EV charging. When EV charging starts, the voltage magnitude at the charger may drop significantly, and the local voltage may carry information not just on the charging rate of the local EV charger, but also charging rates of other chargers on the same or a nearby transformer. The squared voltage magnitude may depend on all current withdrawals on the feeder, not only the charging currents at houses but also non-EV unmeasured currents at houses, and not only by houses connected to the same transformer but also houses that are not. OPF receivers in accordance with several embodiments of the invention may represent the effect of all other factors on voltage using a parameter that summarizes the effect of phase angles of charging currents and line impedances between the transformer and houses. Decentralized charging applications in accordance with several embodiments of the invention implement priority weight configurations for coordinating charging among multiple EVs. In many embodiments, if all EVs are of the same priority, the priority weight can be set to the same value for all EVs (e.g. a priority weight of one). In a number of embodiments, the priority weight may be proportional to the capacity of the main circuit breaker of the house, such that a bigger circuit may be charged at a higher rate. In several embodiments, the priority weight may be proportional to the laxity of the EV, where laxity represents the minimum charging power to meet the EV's energy demand before its deadline. For instance, if an EV needs a certain amount of energy in kilowatt-hours within a certain number of hours, the priority weight may be set to the ratio of the energy demand to the available time.

In a number of embodiments, OPF receivers may assume that the phase angle of the charging current remains unchanged when the smart charger adjusts its current magnitude. The phases of the charging currents may not be measured by the smart chargers, and the effect of the phase angles on voltage may be summarized by a parameter that captures all other factors affecting voltage other than the charging current magnitudes. Processors in accordance with many embodiments of the invention can execute decentralized charging applications that measure voltage sensitivity empirically through perturbation, without requiring knowledge of the exact functional form of the voltage function and its partial derivatives. The ratio of the change in voltage at one charger divided by the change in current at another charger may capture the electrical coupling between the two chargers on the grid.

I/O interfaces in accordance with several embodiments of the invention may facilitate peer-to-peer communication among OPF receivers connected to the same distribution transformer through PLC. In many embodiments, the PLC signal may be blocked by the distribution transformer, which may naturally limit communication to chargers connected to the same distribution transformer. OPF receivers may leverage this property of PLC to automatically communicate only with other OPF receivers on the same transformer without requiring knowledge of which transformer to which the chargers connect. Memory components in accordance with a number of embodiments of the invention may store charging data including (but not limited to) current magnitude values received from other OPF receivers, measured squared voltage magnitude values, lower and upper voltage limit parameters, and/or dual variables for tracking how close measured voltages are to their safe limits.

Although specific OPF receivers are described above with reference to FIG. 3, any of a variety of OPF receiver architectures may be utilized as appropriate to the requirements of specific applications in accordance with various embodiments of the invention. The number and arrangement of processors, I/O interfaces, and memory components may vary depending on the specific implementation. Additionally, the types of data stored in memory and the specific processes implemented by decentralized charging applications may vary based on the requirements of particular installations.

In various embodiments, OPF controllers coordinate charging of electric vehicles connected to distribution transformers while maintaining voltage limits and avoiding transformer overload. OPF controllers in accordance with several embodiments of the invention may be installed at distribution transformers and may communicate with all OPF receivers in households connected to the same transformer. In many embodiments, OPF controllers measure voltage and current at the transformer and compute apparent power values. OPF controllers may receive current magnitude information broadcast from chargers via PLC and may compute sensitivity values based on changes in apparent power resulting from changes in charger current magnitudes. OPF controllers may broadcast computed sensitivity values to chargers via PLC, enabling chargers to adjust charging current magnitudes to avoid overloading the transformer.

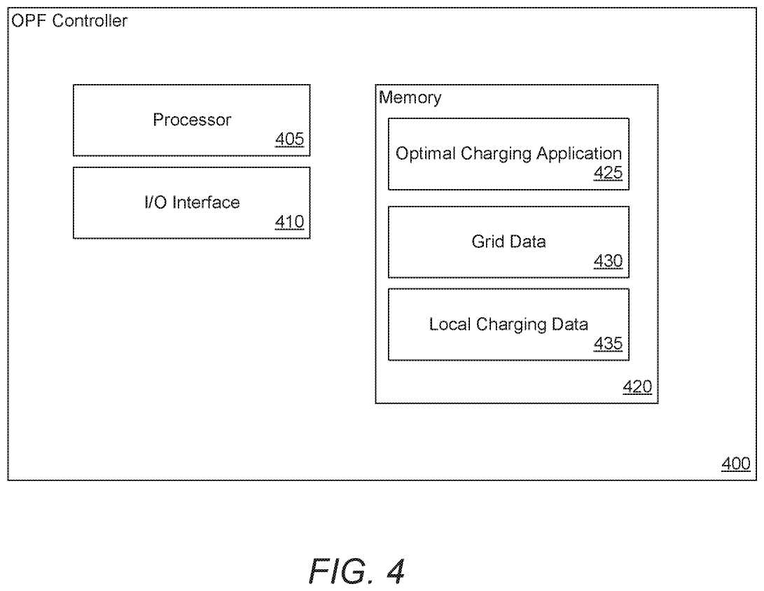

An OPF controller in accordance with an embodiment of the invention is illustrated in FIG. 4. Referring to FIG. 4, an OPF controller 400 includes a processor 405, an I/O interface 410, and a memory 420. The memory 420 contains an optimal charging application 425, grid data 430, and local charging data 435. The processor 405 may execute instructions and perform computations for optimal charging coordination. The I/O interface 410 may facilitate communication with external devices, including communication via PLC with OPF receivers installed in households connected to the same transformer, as well as communication via cellular or cloud connectivity with other OPF controllers on different transformers. The memory 420 may store software and data used by the processor 405. The optimal charging application 425 may include instructions that configure the processor 405 to receive current magnitude information broadcast from chargers, measure apparent power at the transformer, compute apparent power sensitivity values based on changes in apparent power resulting from changes in charger current magnitudes, and broadcast the computed sensitivity values to chargers via PLC. The grid data 430 may store information related to the distribution grid, including transformer capacity ratings and voltage parameters. The local charging data 435 may store information related to charging sessions of electric vehicles connected to the transformer, including current magnitude values received from chargers and measured apparent power values.

In many embodiments, OPF controllers may be installed at distribution transformers and may measure the voltage v₀ and current I₀ received from the feeder head supplying the loads at houses connected to the transformer. OPF controllers in accordance with several embodiments of the invention may communicate via PLC with grid-supporting EV chargers to centrally optimize charging within the transformer. In a number of embodiments, OPF controllers may receive current magnitude values broadcast from chargers and may measure apparent power at the transformer. When a charger changes its current magnitude and broadcasts the change, OPF controllers can measure the new apparent power and compute an apparent power sensitivity value based on the ratio of the change in apparent power to the change in the charger's current magnitude, weighted by how close the apparent power is to the transformer's rated capacity. OPF controllers can broadcast the computed apparent power sensitivity value to chargers via PLC.

Optimal charging applications in accordance with several embodiments of the invention can implement deadline-based charging optimization. In deadline-based charging mode, the goal is to choose charging current magnitudes so as to minimize a certain cost subject to operational constraints as well as the energy demands of the EVs within their deadlines. In many embodiments, each EV may broadcast its energy demand and deadline, where the energy demand represents the remaining energy in kilowatt-hours required and the deadline represents the duration in hours available for charging. OPF controllers can collect these parameters from all EVs and construct an optimization problem. OPF controllers can solve for an optimal solution (or a solution satisfying a specific criteria) and broadcast charging current magnitude information to the chargers. Chargers may then charge their EVs based upon the received charging current magnitudes. In many embodiments, the chargers are able to use this information to implement an optical charging solution.

In a number of embodiments, apparent power at the transformer may be a function of charging current magnitudes and all other factors such as background load and photovoltaic generation. Grid data in accordance with many embodiments of the invention may include a derated transformer rating that serves as the upper limit on apparent power. OPF controllers can track how close the apparent power is to the transformer's rated capacity using a tracking variable. OPF controllers may update the tracking variable based on the difference between the transformer's rated capacity and the measured apparent power, ensuring the result is non-negative. The tracking variable may be used to weight the apparent power sensitivity value, such that the sensitivity value increases as the apparent power approaches the transformer's rated capacity.

In several embodiments, OPF controllers can operate in a grid-supportive mode where OPF controllers on the same distribution feeder communicate with each other through cellular and cloud connectivity and coordinate their control. In grid-supportive mode, OPF controllers at distribution transformers on a distribution feeder may coordinate not only with OPF receivers connected to their own transformers, but also with other OPF controllers via the cloud. Grid-supportive mode may enable feeder-wide services including network identification, where voltage and current measurements by OPF controllers at all the distribution transformers of a feeder and measurements at the substation may be used to identify a network model of a radial distribution grid. OPF controllers in grid-supportive mode may collaboratively and globally optimize EV charging on the feeder and provide grid services such as transformer protection, voltage control, demand response, and/or feeder peak load management.

In various embodiments, OPF controllers can provide feedback to chargers regarding transformer loading conditions without directly throttling or controlling individual chargers. Chargers can update their own charging current magnitudes based on the apparent power sensitivity values received from OPF controllers, in addition to voltage sensitivity values received from other chargers.

Although specific OPF controllers are described above with reference to FIG. 4, any of a variety of OPF controller architectures may be utilized as appropriate to the requirements of specific applications in accordance with various embodiments of the invention. The number and arrangement of processors, I/O interfaces, and memory components may vary depending on the specific implementation. Additionally, the types of data stored in memory and the specific processes implemented by optimal charging applications may vary based on the requirements of particular installations.

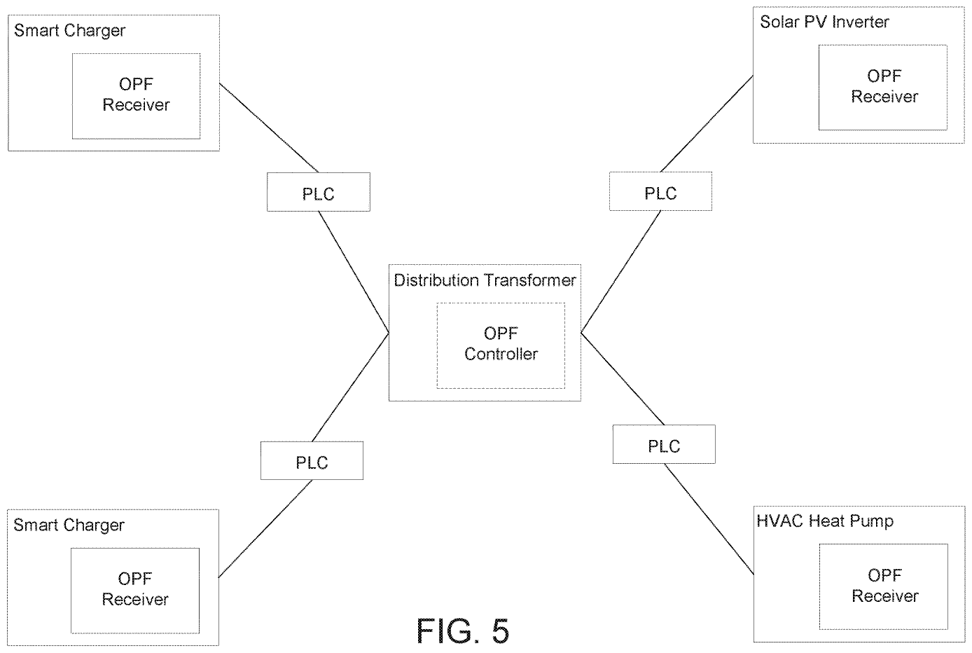

A grid-supportive DER management system in accordance with an embodiment of the invention is illustrated in FIG. 5. As illustrated in FIG. 5, the system includes a solar PV inverter, an HVAC heat pump, smart EV chargers, OPF receivers, and an optional OPF controller, each connected via power line communication (PLC) modules. The solar PV inverter can include an OPF receiver as an embedded device. The HVAC heat pump can also include an OPF receiver as an embedded device. PV inverters and HVAC heat pump may connect to the system via a 40 A 240V connection and communicate through Modbus TCP.

In various embodiments, a 120/240V split phase PLC unit with metering and cellular capability serves as an optional OPF controller. The OPF controller may provide WiFi connectivity to an internet cloud, enabling communication with other OPF controllers on different distribution transformers and facilitating data processing, storage, and analysis.

Smart EV chargers in accordance with many embodiments connect to OPF receivers via Ethernet and support Open Charge Point Protocol (OCPP) 1.6/2.0.1 or Open Automated Demand Response (OpenADR) 2.0 protocols. The smart EV chargers can receive power through 40 A 240V connections. Grid-supportive DER management systems in accordance with a variety of embodiments enable coordination among different types of DERs connected to the same distribution transformer through PLC. OPF receivers embedded in or connected to various DERs may communicate with each other and with an OPF controller to coordinate operation and maintain voltage within safe limits.

Grid-supportive DER management systems in accordance with several embodiments of the invention may provide tariff-based cost optimization. By optimizing EV charging and other DER operation against utility tariff structures, grid-supportive DER management systems may minimize energy costs for users. In a number of embodiments, grid-supportive DER management systems can optimize charging processes under time-of-use (ToU) tariff structures, where the difference between peak and off-peak electricity rates may vary significantly. Grid-supportive DER management systems may receive tariff data from utility systems and may schedule DER operation to take advantage of lower electricity rates during off-peak periods while meeting energy demands within specified deadlines.

In a number of embodiments, grid-supportive DER management systems may provide compatibility with demand response programs via OpenADR. Grid-supportive DER management systems may receive demand response signals from utilities and may adjust DER operation accordingly. In several embodiments, grid-supportive DER management systems may provide grid services such as transformer protection, voltage control, demand response, and feeder peak load management.

Although specific grid-supportive DER management systems are described above with reference to FIG. 5, any of a variety of system architectures including different types of DERs and communication protocols may be utilized as appropriate to the requirements of specific applications in accordance with various embodiments of the invention. The number and arrangement of PLC modules, OPF receivers, and DERs may vary depending on the specific implementation. Additionally, the communication protocols and interfaces used within grid-supportive DER management systems may vary based on the requirements of particular installations.

### Grid-Supportive EV Charging Processes

Decentralized EV charging systems and methods can enable multiple EV chargers connected to the same distribution transformer to coordinate among themselves via PLC to charge efficiently and fairly while maintaining local voltages within safe limits. Decentralized charging may operate without an OPF controller at the distribution transformer, relying instead on peer-to-peer communication among grid-supporting EV chargers. By maintaining local voltages within safe limits, decentralized charging can indirectly reduce the risk of transformer overload.

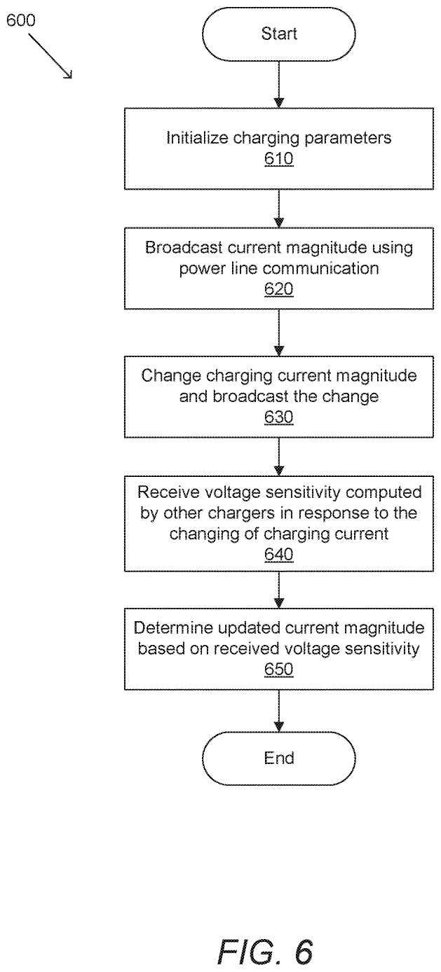

A process for decentralized EV charging in accordance with an embodiment of the invention is illustrated in FIG. 6. Process 600 initializes (610) charging parameters when an EV connects and begins a charging session. For example, when an EV connects and begins charging via EV charger j, processes in accordance with many embodiments of the invention set a root mean square (rms) charging current magnitude xⱼ(0):=0, a lower voltage tracking variable λⱼ(0):=0, and an upper voltage tracking variable λ̅ⱼ(0):=0 when a smart charger begins charging the EV. The lower voltage tracking variable may track how close the measured voltage is to a lower voltage limit, and the upper voltage tracking variable may track how close the measured voltage is to an upper voltage limit. Processes in accordance with several embodiments of the invention may initialize these parameters to zero to establish a baseline state before iterative updates begin. As can readily be appreciated, the specific values to which these parameters are initialized are largely dependent upon the requirements of a given application.

Process 600 broadcasts (620) a current magnitude using PLC. In many embodiments, processes broadcast using PLC the current charging current magnitude xⱼ(t) to all active EV chargers connected to the same distribution transformer. An active EV charger k may receive xⱼ(t) and may measure its squared rms voltage magnitude vₖ(t). The squared voltage magnitude depends on all current withdrawals on the feeder. In many embodiments, the goal of the decentralized charging system is to use information about the manner in which vₖ(t) changes in response to changes in xⱼ(t) to maximize the total charging rates while staying within voltage limits. The PLC signals are typically blocked by the distribution transformer, which may naturally limit communication to chargers connected to the same distribution transformer. Processes in accordance with a number of embodiments of the invention leverage this property of PLC to enable chargers to automatically communicate only with other chargers on the same transformer without requiring knowledge of which transformer the chargers connect to.

Process 600 changes (630) the charging current magnitude and broadcasts the change. In several embodiments, processes change the current magnitude of the EV charger j from xⱼ(t) to xⱼ(t)+Δxⱼ(t), and broadcasts using PLC the increment Δxⱼ(t) to all EV chargers connected to the same transformer. All EV chargers may receive Δxⱼ(t) from the active EV charger and may measure their new squared voltage magnitudes vₖ(t)+Δvₖ(t). Processes in accordance with many embodiments of the invention may use small increments to perturb the charging current magnitude, enabling measurement of voltage sensitivity through empirical observation rather than requiring a detailed model of the distribution grid.

Process 600 receives (640) voltage sensitivity values computed by other chargers in response to the changing of charging current. In many embodiments, all EV chargers compute and broadcast a voltage sensitivity value βₖ(t) to EV charger j. The voltage sensitivity value may be computed according to:

$${β}_{k} ( t ) := ( {\underline{λ}}_{k} ( t ) - {\overline{λ}}_{k} ( t ) ) \frac{Δ {v}_{k} ( t )}{Δ {x}_{j} ( t )} , \qquad ( 1 )$$

where λₖ(t) is the lower voltage tracking variable of the other active EV charger k, λ̅ₖ(t) is the upper voltage tracking variable of the other active EV charger k, Δvₖ(t) is the change in squared voltage magnitude at the other active EV charger k, and Δxⱼ(t) is the change in current magnitude at EV charger j. The voltage sensitivity value may encode how much the voltage at all other EVs changed in response to the current perturbation at EV charger j, weighted by how close the voltage at all other EVs is to its safe limits. EV charger j may receive βₖ(t) from all other EV chargers via PLC.

Process 600 determines (650) an updated current magnitude based on received voltage sensitivity values. In several embodiments, processes update the charging current magnitude of EV charger j based on its priority weight and the sum of all received voltage sensitivity values. The updated charging current magnitude may be computed according to:

xⱼ(t+1)←[xⱼ(t)+γⱼ₁(αⱼ+Σₖβₖ(t))]⁺ (2)

where αⱼ≥0 is a priority weight for EV charger j, γⱼ₁ is a positive stepsize, and [μ]⁺:=max{μ, 0}ensures the result is non-negative. The priority weight may push the current magnitude up while the voltage sensitivity values from other chargers may push the current magnitude down if those chargers are experiencing voltage near their safe limits. Processes in accordance with many embodiments of the invention may also update the lower and upper voltage tracking variables according to:

λⱼ(t+1)←[λⱼ(t)−γⱼ₂(vⱼ(t)−vⱼ)]⁺, (3a)

λ̅ⱼ(t+1)←[λ̅₁(t)−γⱼ₃(v̅ⱼ−vⱼ(t))]⁺, (3b)

where vⱼ is the lower voltage limit, v̅ⱼ is the upper voltage limit, and γⱼ₂ and γⱼ₃ are positive stepsizes. The lower voltage tracking variable may increase when the measured voltage approaches the lower voltage limit, and the upper voltage tracking variable may increase when the measured voltage approaches the upper voltage limit.

In many embodiments, the partial derivative of voltage with respect to current may be negative for EV charging, meaning EV charging suppresses local voltages. When the partial derivative

$$\frac{\partial {v}_{k}}{\partial {x}_{j}} < 0 ,$$

EV charging at one location may reduce the voltage at other locations on the same transformer. In contrast, for PV generation, the partial derivative may be positive, meaning PV generation raises local voltages. When the partial derivative

$$\frac{\partial {v}_{k}}{\partial {x}_{j}} > 0 ,$$

PV generation at one location may increase the voltage at other locations. Processes in accordance with several embodiments of the invention may handle both EV charging and PV generation using the same framework, with the sign of the partial derivative determining whether the DER suppresses or raises local voltages.

In several embodiments, the positive stepsizes (γⱼ₁, γⱼ₂, γⱼ₃) may be selected to be small enough for the process to converge to a solution. If the stepsizes are sufficiently small, the process may converge to a point where the aggregate weighted absolute sensitivity of voltages to each EV charger's current, weighted by optimal tracking variables, equals the priority weight of that EV charger. In many embodiments, if all EV chargers have the same priority weight αⱼ:=1, then at equilibrium, the aggregate weighted sensitivities of voltages may be the same with respect to all charging current magnitudes.

In various embodiments, priority weights may be configured in different ways to coordinate charging among multiple EV chargers. In many embodiments, if all EV chargers are of the same priority, the priority weight may be set to a value of one for all EV chargers. In a number of embodiments, the priority weight may be proportional to the capacity of the main circuit breaker of the house, such that a bigger circuit may be charged at a higher rate. In several embodiments, the priority weight may be proportional to the laxity of the EV charger, where laxity represents the minimum charging power to meet the EV charger's energy demand before its deadline. For instance, if an EV charger needs energy eⱼ kilowatt-hours within dⱼ hours, the priority weight may be set to αⱼ:=eⱼ/dⱼ kilowatts.

Various processes for decentralized EV charging are discussed above with reference to FIG. 6. Alternative processes may be utilized as appropriate to the requirements of specific applications in accordance with various embodiments of the invention. Alternative processes may also be used for decentralized EV charging, including processes that use different step size configurations, different priority weight schemes, or different communication protocols. The number of iterations, the specific values of step sizes, and the particular implementation of PLC may vary depending on the specific installation and the characteristics of the distribution network.

Transformer-protecting EV charging systems and methods may enable an OPF controller installed at a distribution transformer to coordinate the charging of all EVs connected to the distribution transformer to charge efficiently and fairly while maintaining local voltage limits and avoiding transformer overload. In transformer-protecting charging mode, different OPF controllers on different transformers may operate independently of each other, without coordination across OPF controllers. Transformer-protecting charging may add transformer protection to decentralized charging by incorporating apparent power sensitivity values computed by the OPF controller into the charging current magnitude updates performed by smart chargers.

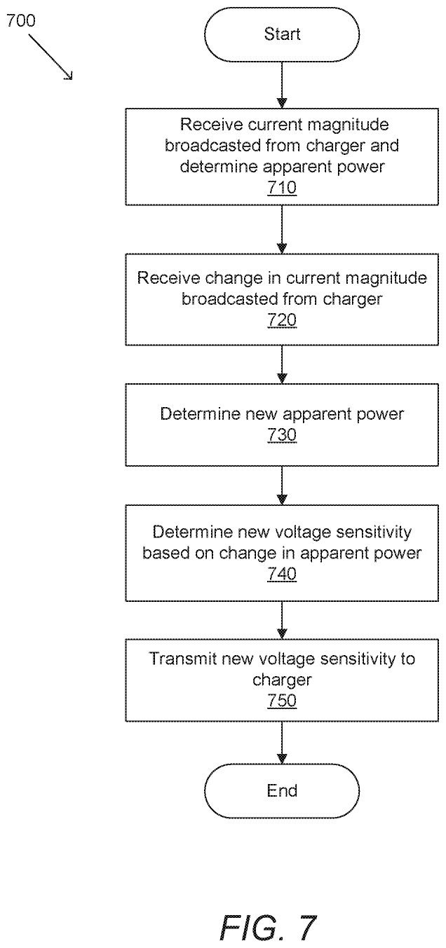

A process for transformer-protecting charging from the perspective of an OPF controller in accordance with an embodiment of the invention is illustrated in FIG. 7. Process 700 receives (710) a current magnitude broadcast from a charger and determines apparent power. In many embodiments, when EV charger j broadcasts using PLC its current charging current magnitude xⱼ(t) to all active EV chargers connected to the same distribution transformer and the OPF controller, the OPF controller receives xⱼ(t) and measures its apparent power s₀(t). The apparent power may be measured in kilovolt-amperes (kVA) at the distribution transformer. Processes in accordance with several embodiments of the invention may measure voltage v₀ and current I₀ received from the feeder head supplying the loads at houses connected to the transformer to determine the apparent power.

Process 700 receives (720) a change in current magnitude broadcast from the charger. In several embodiments, processes receive the change in current magnitude as EV charger j changes its current magnitude from xⱼ(t) to xⱼ(t)+Δxⱼ(t) and broadcasts using PLC the increment Δxⱼ(t) to all EV chargers connected to the same transformer and the OPF controller. Processes in accordance with many embodiments of the invention may receive the current increment without requiring knowledge of the initial current magnitude, as the OPF controller may use the increment to compute the sensitivity ratio.

Process 700 determines (730) a new apparent power. In many embodiments, OPF controllers measure their new apparent power s₀(t)+Δs₀(t) at the transformer based on the received change in current magnitude. The change in apparent power Δs₀(t) may represent the difference between the new apparent power and the previously measured apparent power. Processes in accordance with a number of embodiments of the invention may measure apparent power before and after the perturbation to determine the change in apparent power resulting from the charger's current magnitude change.

Process 700 determines (740) a new voltage sensitivity based on the change in apparent power. In accordance with several embodiments of the invention, the OPF controller computes an apparent power sensitivity value based on the ratio of the change in apparent power to the change in the charger's current magnitude, weighted by how close the apparent power is to the transformer's rated capacity. The apparent power sensitivity value may be computed according to:

$${β}_{0} ( t ) := - {\overline{λ}}_{0} ( t ) \frac{Δ {s}_{0} ( t )}{Δ {x}_{j} ( t )} , \qquad ( 4 )$$

where λ̅₀(t) is an apparent power tracking variable that tracks how close the apparent power is to the transformer's rated capacity, Δs₀(t) is the change in apparent power at the transformer, and Δxⱼ(t) is the change in current magnitude at EV charger j. The apparent power tracking variable may be updated according to:

λ̅₀(t+1)←[λ̅₀(t)−γ₀(s̅₀−s₀(t))]⁺, (5)

where s̅₀ is the derated transformer rating that serves as the upper limit on apparent power, γ₀ is a positive stepsize, and [μ]⁺:=max{μ, 0}ensures the result is non-negative. The apparent power tracking variable may increase when the measured apparent power approaches the transformer's rated capacity.

Process 700 transmits (750) the new voltage sensitivity to the charger. In many embodiments, processes broadcast using the OPF controller, the computed apparent power sensitivity value β₀(t) to the EV charger via PLC. The EV charger can incorporate the apparent power sensitivity value into its charging current magnitude update, in addition to voltage sensitivity values received from other chargers. In accordance with several embodiments of the invention, the charger may update its charging current magnitude according to:

xⱼ(t+1)←[xⱼ(t)+γⱼ₁(αⱼ+Σₖβₖ(t))]⁺

where αⱼ≥0 is a priority weight for EV charger j, γⱼ₁ is a positive stepsize, (βₖ(t) are voltage sensitivity values received from other chargers, and β₀(t) is the apparent power sensitivity value received from the OPF controller.

In many embodiments, the communication and computation performed by a smart charger may remain the same whether or not an OPF controller is present. When an OPF controller is installed at the transformer, the OPF controller may compute and broadcast β₀(t) for each smart charger j to include in its update of xⱼ(t+1).

In a number of embodiments, grid-supportive charging systems may include a multi-subsystem architecture. Grid-supportive charging systems may include subsystems for sensing and data acquisition, communication via cellular, WiFi, powerline, and cloud, data processing, storage and analysis, and real-time control and optimization of DERs. The sensing and data acquisition subsystem may collect voltage and current measurements at distribution transformers and at customer locations. The communication subsystem may enable PLC between OPF receivers and OPF controllers on the same transformer, as well as cellular and cloud connectivity between OPF controllers on different transformers.

In various embodiments, OPF controllers may enable network identification capability. From voltage and current measurements by OPF controllers at all the distribution transformers of a feeder and measurements at the substation, a network model of a radial distribution grid may be identified. OPF controllers in accordance with several embodiments of the invention may enable outage detection capability. Once a reliable real-time network identification scheme is implemented, the network identification scheme may be used to detect outages in the network and alert grid operators.

Various processes for transformer-protecting EV charging are discussed above with reference to FIG. 7. Alternative processes may be utilized as appropriate to the requirements of specific applications in accordance with various embodiments of the invention. Alternative processes may also be used for transformer-protecting EV charging, including processes that use different step size configurations, different apparent power tracking schemes, or different communication protocols. The number of iterations, the specific values of step sizes, and the particular implementation of PLC may vary depending on the specific installation and the characteristics of the distribution network.

In many embodiments, grid-supportive charging systems may operate in one of three modes with increasing functionality and complexity: decentralized charging, transformer-protecting charging, and grid-supporting charging. Processes for transitioning between charging modes may provide graceful fallback mechanisms that allow charging coordination to continue even when an OPF controller becomes unavailable.

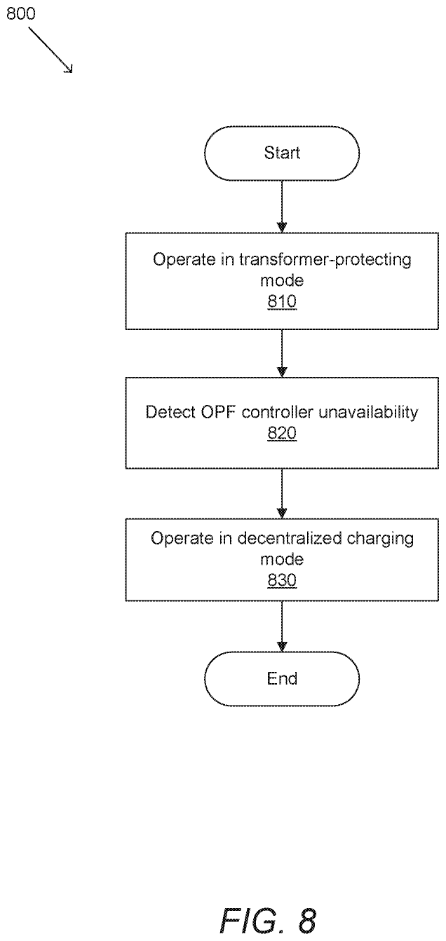

A process for transitioning between charging modes in accordance with an embodiment of the invention is illustrated in FIG. 8. Process 800 operates (810) in transformer-protecting mode. In transformer-protecting mode, a smart charger may receive apparent power sensitivity values from an OPF controller in addition to voltage sensitivity values from other chargers connected to the same distribution transformer. In many embodiments, when an OPF controller is installed at the distribution transformer, the OPF controller may compute and broadcast an apparent power sensitivity value β₀(t) for each smart charger j to include in the smart charger's update of charging current magnitude xⱼ(t+1).

Process 800 detects (820) OPF controller unavailability. In several embodiments, a smart charger may detect that an OPF controller is unavailable when no apparent power sensitivity value is received from the OPF controller within an expected time period. Processes in accordance with many embodiments of the invention may monitor for the presence of apparent power sensitivity values β₀(t) broadcast via PLC from the OPF controller. When the smart charger determines that the OPF controller is unavailable, the smart charger may transition to decentralized charging mode.

Process 800 can then operate (830) in decentralized charging mode. In many embodiments, the process can continue operating using only voltage sensitivity values received from other chargers via PLC, without the apparent power sensitivity value from the OPF controller.

In a number of embodiments, grid-supportive charging systems may also operate in a grid-supporting mode. In grid-supporting mode, OPF controllers installed at different distribution transformers on a distribution feeder may coordinate through the cloud to provide grid services, in addition to efficient, fair, and transformer-protecting charging. In grid-supporting mode, the OPF controllers on the same distribution feeder may communicate with each other through cellular and cloud connectivity and coordinate their control. Grid-supporting mode may enable feeder-wide services including network identification, outage detection, and coordinated EV charging optimization across the feeder. When an OPF controller operating in grid-supporting mode becomes unavailable, the smart chargers connected to that distribution transformer may fall back to decentralized charging mode while other OPF controllers on the feeder may continue operating in grid-supporting mode.

Processes in accordance with several embodiments of the invention may resume transformer-protecting mode when the OPF controller becomes available again. In many embodiments, when the smart charger detects that the OPF controller is available, such as when an apparent power sensitivity value is received, the smart charger may resume operating in transformer-protecting mode. The smart charger may incorporate the apparent power sensitivity value β₀(t) into the charging current magnitude update in addition to voltage sensitivity values received from other chargers. Processes in accordance with a number of embodiments of the invention may provide automatic transition between modes based on the availability of the OPF controller, providing continuous operation of the charging coordination system while maintaining grid protection through voltage-based feedback among the chargers.

Various processes for transitioning between charging modes are discussed above with reference to FIG. 8. Alternative processes may be utilized as appropriate to the requirements of specific applications in accordance with various embodiments of the invention. Alternative processes may also be used for transitioning between charging modes, including processes that use different detection mechanisms for OPF controller availability, different timeout periods for determining unavailability, or different communication protocols. The specific implementation of the fallback mechanism and the particular criteria for detecting OPF controller availability may vary depending on the specific installation and the characteristics of the distribution network.

A number of implementations have been described. Nevertheless, it will be understood that various modifications may be made without departing from the spirit and scope of the disclosure. Accordingly, other implementations are within the scope of the following claims.

What is claimed is:

1. A method for decentralized electric vehicle charging, comprising:
initializing, by a first smart charger connected to a distribution transformer, a charging current magnitude to zero when a first electric vehicle connects to the first smart charger;
broadcasting, by the first smart charger, the charging current magnitude via power line communication to a plurality of other smart chargers connected to the same distribution transformer;
changing, by the first smart charger, the charging current magnitude by an increment and broadcasting the increment via power line communication;
receiving, by the first smart charger, a plurality of voltage sensitivity values from the plurality of other smart chargers via power line communication, wherein each voltage sensitivity value is based upon a change in voltage at a respective other smart charger in response to the increment, weighted by how close the voltage at the respective other smart charger is to a voltage limit; and
determining, by the first smart charger, an updated charging current magnitude based on a priority weight and a sum of the plurality of voltage sensitivity values.

2. The method of claim 1, wherein each voltage sensitivity value is computed according to:
$${β}_{k} ( t ) := ( {\underline{λ}}_{k} ( t ) - {\overline{λ}}_{k} ( t ) ) \frac{Δ {v}_{k} ( t )}{Δ {x}_{j} ( t )}$$
wherein λₖ(t) is a lower voltage tracking variable, λ̅ₖ(t) is an upper voltage tracking variable, Δvₖ(t) is a change in squared voltage magnitude, and Δxⱼ(t) is the increment.

3. The method of claim 1, wherein determining the updated charging current magnitude comprises computing:
xⱼ(t+1)←[xⱼ(t)+γⱼ₁(αⱼ+Σₖβₖ(t))]⁺
wherein αⱼ is the priority weight, γⱼ₁ is a positive stepsize, βₖ(t) are the voltage sensitivity values, and [μ]⁺:=max{μ, 0}.

4. The method of claim 1, further comprising:
receiving, by the first smart charger, an apparent power sensitivity value from an optimal power flow controller installed at the distribution transformer via power line communication, wherein the apparent power sensitivity value is based on a change in apparent power at the distribution transformer in response to the increment, weighted by how close the apparent power is to a rated capacity of the distribution transformer; and
determining the updated charging current magnitude based on the priority weight, the sum of the plurality of voltage sensitivity values, and the apparent power sensitivity value.

5. The method of claim 4, wherein the apparent power sensitivity value is computed according to:
$${β}_{0} ( t ) := - {\overline{λ}}_{0} ( t ) \frac{Δ {s}_{0} ( t )}{Δ {x}_{j} ( t )}$$
wherein λ̅₀(t) is an apparent power tracking variable that tracks how close the apparent power is to the rated capacity of the distribution transformer, Δs₀(t) is a change in the apparent power at the distribution transformer, and Δxⱼ(t) is the increment.

6. The method of claim 4, further comprising:
detecting, by the first smart charger, that the optimal power flow controller is unavailable when no apparent power sensitivity value is received within a specific time period; and
continuing to operate using only the plurality of voltage sensitivity values received from the plurality of other smart chargers without the apparent power sensitivity value.

7. The method of claim 6, further comprising:
detecting, by the first smart charger, that the optimal power flow controller is available when an apparent power sensitivity value is received; and
resuming operation using both the plurality of voltage sensitivity values and the apparent power sensitivity value.

8. The method of claim 1, wherein the first smart charger controls a photovoltaic inverter, and wherein a partial derivative of voltage with respect to current magnitude is positive such that photovoltaic generation raises local voltages.

9. The method of claim 1, further comprising:
receiving, by the first smart charger, an energy demand and a deadline from the first electric vehicle, wherein the energy demand represents remaining energy required and the deadline represents duration available for charging; and
setting the priority weight proportional to a laxity of the first electric vehicle, wherein the laxity is computed as the energy demand divided by the deadline.

10. A smart charger system for decentralized electric vehicle charging, comprising:
an optimal power flow receiver comprising:
a processor;
an input/output interface configured to communicate via power line communication with a plurality of other smart chargers connected to a same distribution transformer; and
a memory storing a decentralized charging application that, when executed by the processor, causes the processor to:
initialize a charging current magnitude to zero when an electric vehicle connects;
broadcast the charging current magnitude via power line communication to the plurality of other smart chargers;
change the charging current magnitude by an increment and broadcast the increment via power line communication;
receive a plurality of voltage sensitivity values from the plurality of other smart chargers via power line communication, wherein each voltage sensitivity value is based upon a change in voltage at a respective other smart charger in response to the increment, weighted by how close the voltage at the respective other smart charger is to a voltage limit; and
determine an updated charging current magnitude based on a priority weight and a sum of the plurality of voltage sensitivity values.

11. The smart charger system of claim 10, wherein each voltage sensitivity value is computed according to:
$${β}_{k} ( t ) := ( {\underline{λ}}_{k} ( t ) - {\overline{λ}}_{k} ( t ) ) \frac{Δ {v}_{k} ( t )}{Δ {x}_{j} ( t )}$$
wherein λₖ(t) is a lower voltage tracking variable, λ̅ₖ(t) is an upper voltage tracking variable, Δvₖ(t) is a change in squared voltage magnitude, and Δxⱼ(t) is the increment.

12. The smart charger system of claim 10, wherein the decentralized charging application further causes the processor to determine the updated charging current magnitude by computing:
xⱼ(t+1)←[xⱼ(t)+γⱼ₁(αⱼ+Σₖβₖ(t))]⁺
wherein αⱼ is the priority weight, γⱼ₁ is a positive stepsize, βₖ(t) are the voltage sensitivity values, and [μ]⁺:=max{μ, 0}.

13. The smart charger system of claim 10, further comprising:
an optimal power flow controller installed at the distribution transformer, the optimal power flow controller comprising:
a second processor;
a second input/output interface configured to communicate via power line communication with the optimal power flow receiver; and
a second memory storing an optimal charging application that, when executed by the second processor, causes the second processor to:
receive the charging current magnitude broadcast from the optimal power flow receiver;
measure apparent power at the distribution transformer;
receive the increment broadcast from the optimal power flow receiver;
measure a new apparent power at the distribution transformer;
compute an apparent power sensitivity value based on a ratio of a change in apparent power to the increment, weighted by how close the apparent power is to a rated capacity of the distribution transformer; and
broadcast the apparent power sensitivity value to the optimal power flow receiver via power line communication.

14. The smart charger system of claim 13, wherein the decentralized charging application further causes the processor to:
receive the apparent power sensitivity value from the optimal power flow controller via power line communication; and
determine the updated charging current magnitude based on the priority weight, the sum of the plurality of voltage sensitivity values, and the apparent power sensitivity value.

15. The smart charger system of claim 13, wherein the apparent power sensitivity value is computed according to:
$${β}_{0} ( t ) := - {\overline{λ}}_{0} ( t ) \frac{Δ {s}_{0} ( t )}{Δ {x}_{j} ( t )}$$
wherein λ̅₀(t) is an apparent power tracking variable that tracks how close the apparent power is to the rated capacity of the distribution transformer, Δs₀(t) is a change in apparent power at the distribution transformer, and Δxⱼ(t) is the increment.

16. The smart charger system of claim 13, wherein the decentralized charging application further causes the processor to:
detect that the optimal power flow controller is unavailable when no apparent power sensitivity value is received within a specific time period; and
continue to operate using only the plurality of voltage sensitivity values received from the plurality of other smart chargers without the apparent power sensitivity value.

17. The smart charger system of claim 16, wherein the decentralized charging application further causes the processor to:
detect that the optimal power flow controller is available when an apparent power sensitivity value is received; and
resume operation using both the plurality of voltage sensitivity values and the apparent power sensitivity value.

18. The smart charger system of claim 10, wherein the optimal power flow receiver is configured to control a photovoltaic inverter, and wherein a partial derivative of voltage with respect to current magnitude is positive such that photovoltaic generation raises local voltages.

19. The smart charger system of claim 10, wherein the decentralized charging application further causes the processor to:
receive an energy demand and a deadline from the electric vehicle, wherein the energy demand represents remaining energy required and the deadline represents duration available for charging; and
set the priority weight proportional to a laxity of the electric vehicle, wherein the laxity is computed as the energy demand divided by the deadline.

20. The smart charger system of claim 13, wherein the optimal charging application further causes the second processor to:
collect energy demands and deadlines from a plurality of electric vehicles connected to the distribution transformer;
construct an optimization problem to minimize a cost function subject to voltage constraints, apparent power constraints, and energy demand constraints; and
broadcast optimal charging current magnitudes to the plurality of electric vehicles.
